(19) United States
(12) Patent Application Publication
(10) Pub. No.: US 2026/0169777 A1
(43) Pub. Date: Jun. 18, 2026

(54) MEMORY MANAGEMENT AND ERROR PREVENTION IN HYPERVISOR ENVIRONMENTS

(71) Applicant: International Business Machines Corporation, Armonk, NY (US)

(72) Inventors: Walter Church, IV, Scotch Plains, NJ (US); Richard John Moore, Waterlooville (GB); Justin VanSlocum, Mead, CO (US); Andreas Vischer, Altdorf (DE)

(21) Appl. No.: 18/980,009

(22) Filed: Dec. 13, 2024

(51) Int. Cl. G06F 9/455

(52) U.S. Cl. CPC G06F 9/45558; G06F 2009/45583

(57) ABSTRACT

A present invention embodiment prevents errors and manages memory in a hypervisor environment. Memory index values are obtained for a host memory of a hypervisor and a guest memory of a guest of a hypervisor, wherein the host memory is accessible by a hardware adapter of the hypervisor, and wherein the host memory is configured to be synchronized with the guest memory. A store index instruction issued by the virtual device is intercepted that includes input index values. The store index instruction is determined to be valid by comparing each input index value to a corresponding host memory index value in the host memory and to a guest memory index value in the guest memory. In response to determining that the store index instruction is valid, the host memory shared with the adapter is synchronized with the guest memory based on the input index values.

### BACKGROUND

### 1. Technical Field

Present invention embodiments relate to hypervisors and virtual machines, and more specifically, to memory management and error prevention in a hypervisor environment.

### 2. Discussion of the Related Art

A hypervisor refers to software and/or hardware that enables multiple operating systems, called guests or virtual machines, to run concurrently on a single physical computing device. A hypervisor manages physical resources, such as CPU, memory, storage, and networking, by allocating the resources to the guests, enabling each guest to operate as if it had its own dedicated hardware. When a guest issues input/output (I/O) instructions, the instructions may be intercepted by the hypervisor, meaning that the hypervisor simulates the instructions on behalf of the guest.

### SUMMARY

According to one embodiment of the present invention, a system is provided for preventing errors and managing memory in a hypervisor environment. Memory index values are obtained for a host memory of a hypervisor and a guest memory of a guest of a hypervisor, wherein the guest memory is associated with a virtual device of the guest, wherein the host memory is accessible by a hardware adapter of the hypervisor, and wherein the host memory is configured to be synchronized with the guest memory. A store index instruction issued by the virtual device is intercepted, wherein the store index instruction comprises a plurality of input index values. The store index instruction is determined to be valid by comparing each input index value to a corresponding host memory index value in the host memory and to a corresponding guest memory index value in the guest memory. In response to determining that the store index instruction is valid, the plurality of input index values are stored to the guest memory and the host memory is synchronized with the guest memory. Embodiments of the present invention further include a method and computer program product for preventing errors and managing memory in a hypervisor environment in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a block diagram of hypervisor code according to an embodiment of the present invention.

FIG. 3 is a block diagram of a virtualization environment according to an embodiment of the present invention.

FIG. 4 is a flowchart of a method for performing preventative checks in a hypervisor environment according to an embodiment of the present invention.

FIG. 5 is a flowchart of a method for processing store index instructions in response to an error according to an embodiment of the present invention.

FIG. 6 is a flowchart of a method for processing store index instructions in response to an error according to an embodiment of the present invention.

### DETAILED DESCRIPTION

A present invention embodiment relates to hypervisors and virtual machines, and more specifically, to memory management and error prevention in a hypervisor environment. In a hypervisor architecture, a hypervisor abstracts the physical hardware and presents virtual hardware to each guest (which are also referred to as virtual machines). This process of virtualization enables guests to behave as though each guest has its own independent hardware, even though multiple guests may share the underlying physical hardware elements. Thus, while devices may appear as physical hardware from the perspective of a guest, the devices may be virtualized by the hypervisor, meaning that the hypervisor intercepts and manages the instructions as the guest may not have access to the underlying physical hardware.

An Input/Output (I/O) instruction refers to a command issued by a guest to an adapter, which is an I/O device such as a processor, storage, memory, network interface, or other peripheral hardware. In some hypervisor architectures, the memory queues of I/O instructions are handled with shadow queues. The shadow memory serves as a bridge between a guest's virtual memory and the physical memory of a hardware device. Since physical hardware may not be able to directly access the virtual memory of a guest, the shadow memory is synchronized with the guest's virtual memory. The shadow memory is hosted in the hypervisor and managed by the hypervisor's control program, and unlike the guests'virtual memory, the shadow memory is accessible by the physical hardware.

Thus, when certain instructions are issued by a guest, the contents of the guest's memory are synchronized into the host memory in the form of a shadow queue. However, in some cases an instruction may include incorrect index values that would cause the wrong memory contents to be moved into the host memory, thereby corrupting the queue. Additionally, errors can be encountered even when an instruction includes correct index values; in such cases, the shadow queue is conventionally resynchronized with the next instruction's queue. However, such resynchronization can be unnecessary, as the next instruction may not include any changed values.

In either case, it is desirable to avoid unnecessary shadow queue synchronization operations, as these operations involve flushing pinned memory, moving data from storage block page entries of the guest queue to the shadow queue, and pinning the memory contents, which can be computationally expensive in terms of both processing resources and time required. The embodiments presented herein address this problem by performing preventative checks to ensure that instructions include correct index values, and by reusing pinned memory queues when it is determined that the next instruction will likely utilize the same data. In particular, an instruction's input index values can be compared to the guest queue and/or the shadow queue to ensure that the index values are valid (e.g., that the instruction would not write over memory addresses currently held by an adapter). Additionally, when errors are encountered, the decision of whether to flush and repin the queues or to re-use the current queues is made based on the frequency in which re-using a current queue was successful with respect to previously-encountered errors. Thus, if the ratio of successful re-uses to memory replacements is beyond a threshold value, the current queue may be reused.

Present invention embodiments thus improve the technical field of virtualization by implementing preventative mechanisms that reduce or eliminate errors in relation to memory management, while also improving the efficiency of computing by reducing unnecessary memory operations. The embodiments presented herein provide several practical applications, including reducing processing requirements and memory operations, and reducing or eliminating errors. Moreover, memory hashing techniques are presented herein that enable memory to be analyzed more efficiently and more quickly.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

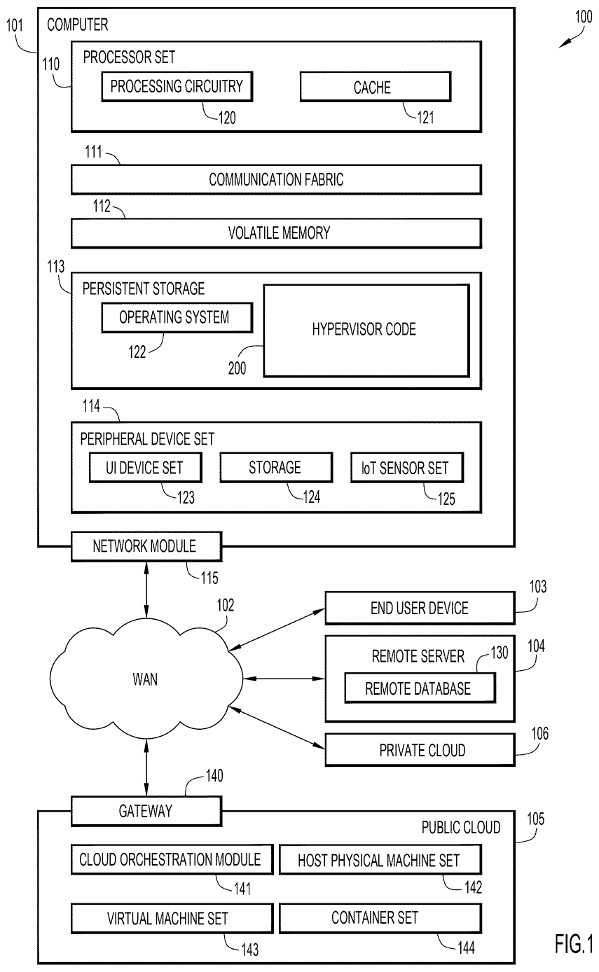

Referring to FIG. 1, computing environment 100 contains an example of an environment for the execution of at least some of the computer code involved in performing the inventive methods, such as hypervisor code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

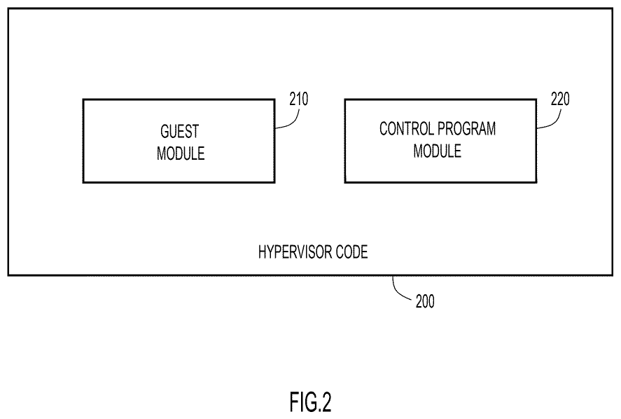

A block diagram of hypervisor code 200 according to an embodiment of the present invention is illustrated in FIG. 2. Specifically, hypervisor code 200 includes at least a guest module 210 and a control program module 220. Guest module 210 and control program module 220 may include one or more modules or units to perform various functions of present invention embodiments described herein. Guest module 210 and control program module 220 may be implemented by any combination of any quantity of software and/or hardware modules or units, and may reside within volatile memory 112 of computer 101 for execution by a processor, such as processor set 110.

Guest module 210 may include instructions for implementing one or more guests (i.e., virtual machines) of a hypervisor. Guest module 210 can include images of guests that can be instantiated and provided with resources by a host hypervisor, including virtual computing resources that can access the underlying physical hardware via the hypervisor. The guest module 210 may include an operating system and one or more programs (e.g., a word processor, a browser, etc.). Each guest may include various virtual devices, such as I/O devices like network interfaces, storage, graphics, and processors, and each guest may include virtual device drivers for each virtual device. Each guest may include virtual memory that is managed by the guest. In various embodiments, each guest may include monitoring tools that track computing resource usage within the guest environment, security components such as a firewall, user access control tools, authentication tools, and the like.

Control program module 220 may perform various operations relating to virtualization of guests/virtual machines by a hypervisor, including managing computing resources of guests in accordance with the embodiments presented herein. Control program module 220 may include a monitoring function that manages processor execution, including intercepting instructions that require hypervisor control. Control program module 220 may create guests and isolate guests from each other as well as the underlying hardware. A hypervisor kernel may be included that is similar to an operating system kernel; the hypervisor kernel can manage low-level hardware resources (e.g., processors, memory, I/O) and distribute these resources among the guests. Other functions of control program module 220 may include memory management functions, a scheduler for shared resources (e.g., physical hardware), security mechanisms, administrative access functions, and the like.

Control program module 220 may perform interception and interpretation of I/O instructions of a guest. When an instruction is interpreted, it is passed to the processor, which may initiate a request to a device. When an instruction is intercepted, it is passes to the hypervisor, which may initiate or simulate a request to a device. Control program module 220 may manage a shadow memory queue, which is synchronized to the guest's virtual memory and which is accessible to a physical device, such as an I/O adapter

Control program module 220 may be configured to perform preventative checks in order to ensure that execution of instructions will not corrupt any queues. When an instruction is issued, the instruction includes data that will be moved from the guest memory to the host memory (i.e., the shadow memory) and from the shadow memory to the physical memory of an adapter. For a store index instruction, memory index values are handled in this manner. For example, a Store Control Program Queue Controls (SCPQC) instruction, the contents of each storage block page entry (SBPE) will be moved from guest to host memory. However, if a guest issues an SCPQC with incorrect index values, the incorrect contents would be moved into the host memory, potentially in address ranges that are still being processed by an adapter, which would corrupt the queue. Thus, control program module 220 may perform a preventative check by comparing each input index value of a guest store index instruction against the currently-stored adapter index values and queue index values to determine of any input index values are out of bounds, and if so, the guest instruction is not executed.

Additionally or alternatively, control program module 220 may perform memory shadowing operations that enable unnecessary shadow queue synchronizations to be avoided, thereby saving computing resources. When a store index instruction returns an error condition, the conventional approach is to un-pin any memory and clear the contents of the shadow memory. However, if the guest does not make changes to the queue and issues another store index instruction, the shadow memory synchronization must be performed again, even though the memory that was cleared would have contained the same contents. This adds overhead for the guest and results in an unnecessary repeat of operations previously performed.

In order to address this problem, control program module 220 may be configured to predict when memory contents should be replaced or re-used. Control program module 220 may implement two counters that are used to determine when memory contents should be replaced versus re-used. The counters may be initialized on a per-queue basis, and can be updated after a store index instruction is reissued by the guest and the memory contents are compared to the store index instruction's index values. In order to quickly compare, hashing can be performed to identify whether the memory queues match (i.e., have the same hash) or if there is a change to the memory queues (i.e., do not have the same hash). The counters may include a replace counter and a success counter that are initialized to a default value (e.g., 0, 1, etc.), and which are incremented depending on whether the memory queues match or do not match. If the memory queues match, then the success counter may be incremented, and if the memory queues do not match, then the replace counter can be incremented. When a new store index instruction is issued by the guest, the ratio of the success counter's value to the replace counter's value can be compared to a threshold value, and if the ratio exceeds the threshold (i.e., there are more success events than replace events in the past beyond a particular threshold), then the current memory may be re-used. Thus, the decision of whether to replace or re-use memory queues can be predicted based on previous events, which may be indicative of particular trends that enable unnecessary replace and shadow operations to be performed.

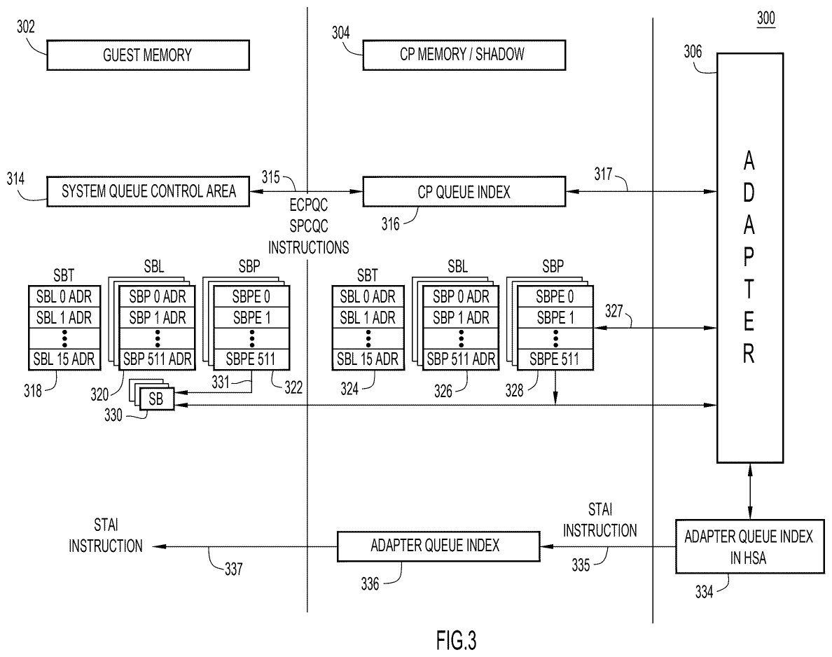

With reference now to FIG. 3, a block diagram is provided of a virtualization environment 300 according to an embodiment of the present invention. As depicted, the virtualization environment 300 includes guest memory 302, control program (CP) memory 304 (i.e., shadow memory), and an adapter 306. The guest memory 302 corresponds to virtual memory of a hypervisor's guest, and the CP memory 304 corresponds to shadow memory that is managed by the control program of a hypervisor. Adapter 306 may include any actual physical or virtual device (such as a network or storage adapter) with which a guest interacts. Adapter 306 may perform the I/O operations requested by a guest and is managed by the hypervisor through the shadowed structures. In some embodiments, adapter 306 is a virtual representation that corresponds to a physical device managed by the hypervisor through the shadow structures. Thus, I/O operations by a guest are taken out of the control program through the means of interception or interpretation.

Guest memory 302 includes a system queue control area 314, a Storage Block Table (SBT) 318, a Storage Block List (SBL) 320, a Storage Block Page (SBP) 322, and Storage Blocks (SBs) 330. CP memory 304 includes analogous shadow versions of some of these data structures, SBT 324, SBL 326, and SBP 328. CP memory 304 also includes CP Queue Index 316 and Adapter Queue Index 336.

System Queue Control Area 314 may be a control area that is configured to maintain information on various queues in guest memory, including the current status and configuration. As such, System Queue Control Area 314 may store details on queue priority, status flags, and/or the relationship between multiple queues.

SBT 318, SBL 320, and SBP 322 may include different levels or types of storage blocks for index values of issued instructions. SBT 318 may reference addresses in SBL 320, and SBL 320 may in turn reference addresses in SBP 322. For example, “SBL 0 ADR” may reference a 0 address in SBL 320, and “SBL 1 ADR” may reference a 1 address in SBP 322. SBP 322 may include entries (SBPEs) that represent the underlying index values, whereas SBL 320 references ranges of SBPEs, and in turn, SBT 318 references ranges of SBL 320 entries. SB 330 may include one or more memory blocks that store the actual data referenced by the index values of SBT 318, SBL 320, and SBP 322, as indicated by operation 331.

Any of SBT 318, SBL 320, and/or SBP 322 (and their analogous shadow counterparts) may be implemented as a ring buffer structure, which is a circular data structure. A ring buffer may be a fixed-size buffer that includes two pointers, a write pointer for placing new data into the buffer, and a read pointer for consuming or processing data from the buffer. When data is being written to, or read from, the ring buffer, and either the write or read pointer reaches the end of the buffer, the pointer will wrap around to the beginning (e.g., index 0) of the buffer, an occurrence referred to as a ring wrap. While this behavior allows for continuous use of the buffer space without the need to resize the buffer or move data around, in some cases, a ring wrap may cause data that is currently being used by an element (e.g., adapter 306) to be overwritten.

CP memory 304 may include several shadow structures that are analogous to their counterparts in guest memory 302, and may be synchronized with the corresponding analogous structures to enable data access by adapter 306. The shadow structures include SBT 324, SBL 326, and SBP 328. The shadow structures enable the hypervisor to track and manage guest memory mappings accurately, ensuring that I/O operations are handled correctly without compromising isolation between guests. SBP 328 may receive output (i.e., the output results of an I/O operation) from adapter 306 at operation 327, which can be provided to SB 330 at operation 329.

Also included in CP memory 304 is a CP Queue Index 316, which maintains the current state of the queues being used by the hypervisor for tracking guest operations. The CP Queue Index 316 enables the CP to determine the next or current operation to process. The CP Queue Index 316 may synchronize instructions with System Queue Control Area 314 (operation 315). These instructions may include Extract CP Queue Controls (ECPQC) and/or Store CP Queue Controls (SCPQC), and may manage the queue structures by updating queue indices, enqueuing requests, and/or synchronizing queue states between guest and CP memory. CP Queue Index 316 may receive data from adapter 306, as shown at operation 317, including new indexes being filled to use with the SCPQC.

The Adapter Queue Index 336 may may synchronize with the adapter queue index in the hardware system area (HSA) 334 to forward Store Adapter Index (STAI) instructions (operation 335), which are then provided to the guest (operation 337). The STAI instructions may then be provided to the guest at operation 337. The STAI instructions provide the adapter indexes for all queues; as such, STAI instructions can obtain all input or output queue indexes to determine how much work has been done by the adapter 306. Adapter Queue Index 336 also synchronize with the CP Queue Index 316 to ensure that the guest and CP views of the queue state align with the view of adapter 306.

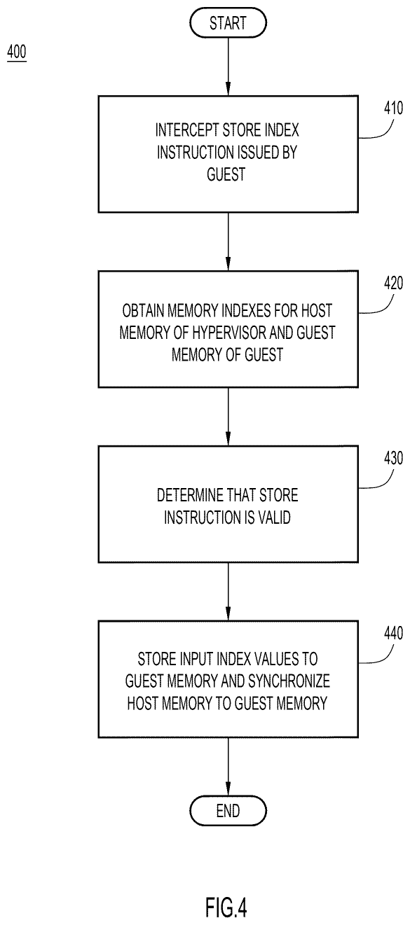

With reference now to FIG. 4, a flowchart is provided of a method 400 for performing preventative checks in a hypervisor environment according to an embodiment of the present invention.

A store index instruction that is issued by a guest is intercepted at operation 410. The store index instruction may be a store control program queue controls (SCPQC) instruction that includes its own input index values, as well as other data. Conventionally, these input index values would be stored in the guest memory and synchronized in the shadow memory. However, the embodiments presented herein instead perform a preventative check (operation 430) to ensure that providing the input index values to memory would not overwrite any addresses currently in use by an adapter.

Memory indexes values for a host memory of a hypervisor and a guest memory of a guest are obtained at operation 420. The memory index values are references to data locations in storage blocks, and are stored in specific locations in guest memory and the shadow memory of a hypervisor. In particular, the storage block page entries (SBPEs) refer to specific entries in a memory queue ring; for example, index 0 refers to SBPE 0. The shadow memory is synchronized to the guest memory so that the guest memory's SBPEs contain the same contents. Thus, a hypervisor's control program obtains the memory index values from the guest memory as well as the shadow memory.

The store index instruction is determined to be valid by comparing each input index value to corresponding host memory index values and guest memory index values at operation 430. Initially, STAI and/or ECPQC instructions are issued by the hypervisor to obtain the index values from the guest memory and the shadow memory. Next, the input index values of the store index instruction are compared to the index values of the guest memory and the shadow memory to determine whether any index values of the guest memory and shadow memory that are in use by an adapter (e.g., adapter-owned SBPEs) would be overwritten if the input index values are provided to the queues. This check can determine if a ring wrap would occur in order to check the addresses that extend beyond the beginning of the buffer. If any indexes are out of bounds, a condition code value of not zero (e.g., CC< >0) can be returned to the guest, and in response, the host will not execute the store index instruction.

In response to determining that the store index instruction is valid, data is stored to the guest memory and synchronized with the host memory at operation 440. The index values are processed by the host to determine which SBPE entries should be synchronized between the guest and host. The SBPE entries indicate the storage buffers that hold the actual data payload that is synchronized.

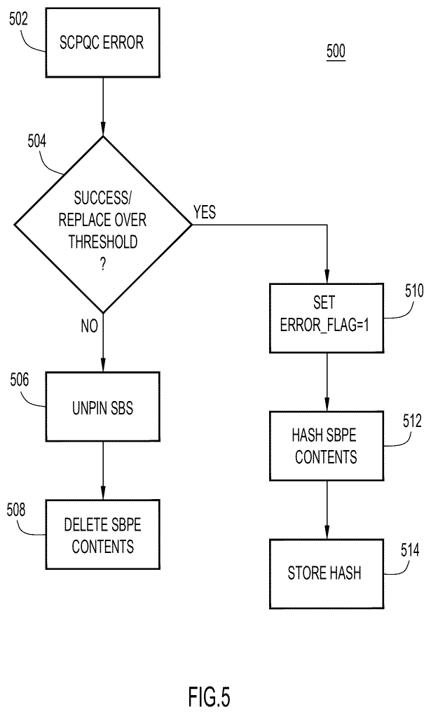

FIG. 5 is a flowchart of a method 500 for processing store index instructions in response to an error according to an embodiment of the present invention.

An SCPQC error occurs at operation 502. The SCPQC error may be indicated by a particular condition code that is returned. The condition code can be a subchannel not queue direct input output (QDIO) active condition code, a designated subchannel not operation conditional code, or any other defined condition code that indicated that there has been an error relating to a store index instruction.

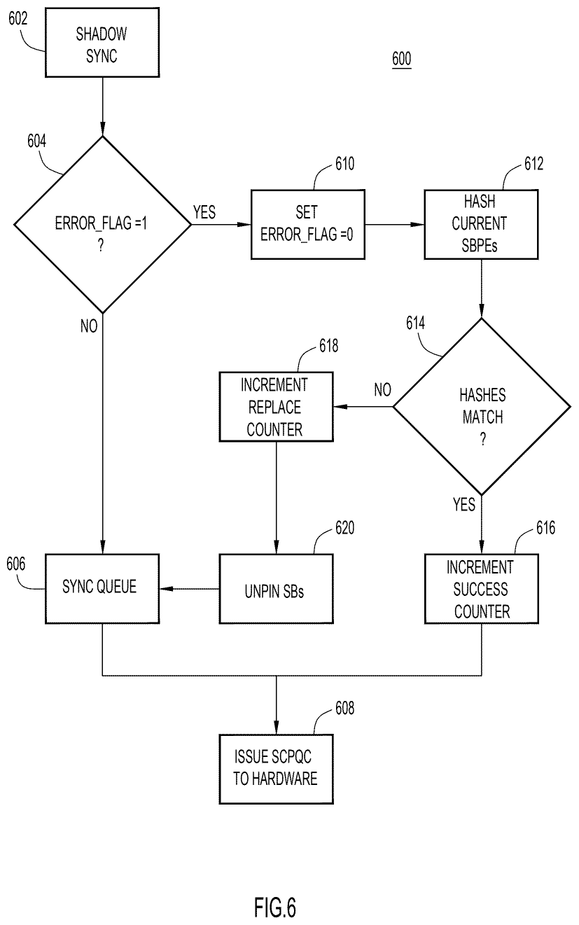

Operation 504 determines whether the success counter to replace counter ratio is over a threshold. The success counter and the replace counter are described in further detail with reference to FIG. 6 below, as method 600 operates in conjunction with method 500. The success counter is incremented each time that re-using the SBPE contents is successful, and the replace counter is incremented when re-using the SBPE contents is unsuccessful, meaning that the SBPE contents had to be unpinned from memory, deleted, and replaced. The threshold may be any desired value, and can be set or modified manually or by the hypervisor in response to certain conditions occurring. For example, the threshold value may be lowered when the SBPE contents have not had to be replaced for a certain number of operations and/or duration of time.

If the success counter to replace counter does not satisfy the threshold, then the storage blocks are unpinned at operation 506, and deleted at operation 608. The SBPE will then be updated by a subsequent SCPQC instruction.

In the case that the success counter to replace counter ratio does satisfy the threshold, method 500 proceeds to set an error flag to a particular value at operation 510. This error flag value (e.g., Error_Flag=1) can be used by the hypervisor to track that an SCPQC error has occurred, and that the success counter to replace counter is over the threshold, indicating that re-using the SBPE values has been more successful than not in the past. Next, at operation 512, a hash of the SBPE contents is generated and stored at operation 614. This hash will be used in method 600 for determining whether the SBPE contents require replacing.

FIG. 6 is a flowchart of a method 600 for processing store index instructions in response to an error according to an embodiment of the present invention.

A shadow synchronization request is received at operation 602. The request may be received when a next store index instruction is issued by a guest. Operation 604 determines whether the error flag has been set, which occurs when a store index instruction error is encountered in method 500. If there is no error flag (e.g., Error_Flag does not equal 1), then method 600 proceeds to synchronize the shadow queue with the guest queue at operation 606, and the SCPQC instruction is issued to the hardware (e.g., an adapter) at operation 608.

If the error flag has been set, (e.g., Error_Flag=1), then method 600 proceeds to operation 610, which resets the error flag (e.g., Error_Flag=0).

At operation 612, the current SBPE values are hashed. These values may be obtained from the shadow memory and/or the guest memory. At operation 614, the current hash is compared to the hash of the more recently-issued SCPQC instruction in method 500 (i.e., the hash that is generated based on the instruction's input index values at operation 512 of method 500). If there is a difference in the hashes, then the input index values are different from the current index values, and the memory contents will be replaced. The replace counter is thus incremented at operation 618, and the SBs are unpinned at operation 620. While hashing is used to more quickly detect differences, it should be appreciated that in other embodiments, the memory contents can be compared directly. At operation 606, the shadow queue is synchronized with the new index values in the guest memory, and the SCPQC instruction is issued to the hardware at operation 608.

If the hashes match at operation 614, then the memory contents can be reused, and the success counter is incremented at operation 616. The current SBPE contents are then used when the SCPQC instruction is issued to the hardware at operation 608.

It will be appreciated that the embodiments described above and illustrated in the drawings represent only a few of the many ways of implementing embodiments for improved memory management with respect to I/O instructions in a hypervisor environment.

The environment of the present invention embodiments may include any number of computer or other processing systems (e.g., any computing device, computing service, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system. These systems may include any types of monitors and input devices (e.g., keyboard, mouse, voice recognition, etc.) to enter and/or view information.

It is to be understood that the software of the present invention embodiments (e.g., hypervisor code 200, elements of virtualization environment 300, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client, distributed computing, and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the computing system. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., guest data, virtual device data, hypervisor data, buffer queue data, interception control data, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The guest data, virtual device data, hypervisor data, buffer queue data, guest memory data, shadow memory data, and/or any other data may include any information arranged in any fashion, and may be configurable based on rules or other criteria to provide desired information to a user.

The present invention embodiments are not limited to the specific tasks or algorithms described above, but may be utilized for improving execution of I/O instructions in any virtualization environment.

The data may include any format of storing data and may include any data descriptive of databases, including metadata and indexes thereof. The data may be obtained via any techniques, and may be accessed over a network, fetched from local storage, provided via user input, and the like.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
obtaining memory index values for a host memory of a hypervisor and a guest memory of a guest of the hypervisor, wherein the guest memory is associated with a virtual device of the guest, wherein the host memory is accessible by a hardware adapter of the hypervisor, and wherein the host memory is configured to be synchronized with the guest memory;
intercepting a store index instruction issued by the guest, wherein the store index instruction comprises a plurality of input index values;
determining that the store index instruction is valid by comparing each input index value to a corresponding host memory index value in the host memory and to a corresponding adapter memory index value in an adapter memory; and
in response to determining that the store index instruction is valid, synchronizing the host memory shared with the adapter with the guest memory based on the plurality of input index values.

2. The computer-implemented method of claim 1, wherein determining that the store index instruction is valid further comprises:
in response to determining that the store index instruction causes a ring wrap to occur in the guest memory or the host memory, determining that the store index instruction does not overwrite host memory index values currently held by the hardware adapter.

3. The computer-implemented method of claim 1, wherein the store index instruction comprises a store control program queue controls instruction that stores a state of one or more input/output queues.

4. The computer-implemented method of claim 1, further comprising:
executing the store index instruction by the hardware adapter.

5. The computer-implemented method of claim 1, wherein the guest memory and the host memory each comprise a plurality of storage blocks, the plurality of storage blocks comprising at least a first storage block having index values that each reference a range of index values in a second storage block.

6. The computer-implemented method of claim 1, further comprising:
providing a replace counter and a success counter, wherein the replace counter is incremented when a storage instruction error occurs and storage block page entry contents referenced by the plurality of input index values do not match currently-stored values in the host memory, and wherein the success counter is incremented when the storage instruction error occurs and the storage block page entry contents do match currently-stored values in the host memory; and
in response to the guest issuing a subsequent store index instruction, utilizing the currently-stored values in the host memory for execution of the subsequent store index instruction when a ratio of the success counter to the replace counter exceeds a threshold value.

7. The computer-implemented method of claim 6, wherein determining that the storage block page entry contents do or do not match the currently-stored values in the host memory comprises comparing a first hash of the storage block page entry contents to a second hash of the currently-stored values.

8. A computer system comprising:
a processor set;
one or more computer-readable storage media; and
program instructions stored on the one or more computer-readable storage media to cause the processor set to perform operations comprising:
obtaining memory index values for a host memory of a hypervisor and a guest memory of a guest of the hypervisor, wherein the guest memory is associated with a virtual device of the guest, wherein the host memory is accessible by a hardware adapter of the hypervisor, and wherein the host memory is configured to be synchronized with the guest memory;
intercepting a store index instruction issued by the guest, wherein the store index instruction comprises a plurality of input index values;
determining that the store index instruction is valid by comparing each input index value to a corresponding host memory index value in the host memory and to a corresponding adapter memory index value in an adapter memory; and
in response to determining that the store index instruction is valid, synchronizing the host memory shared with the adapter with the guest memory based on the plurality of input index values.

9. The computer system of claim 8, wherein determining that the store index instruction is valid further comprises:
in response to determining that the store index instruction causes a ring wrap to occur in the guest memory or the host memory, determining that the store index instruction does not overwrite host memory index values currently held by the hardware adapter.

10. The computer system of claim 8, wherein the store index instruction comprises a store control program queue controls instruction that stores a state of one or more input/output queues.

11. The computer system of claim 8, wherein the program instructions further cause the processor set to perform operations comprising:
executing the store index instruction by the hardware adapter.

12. The computer system of claim 8, wherein the guest memory and the host memory each comprise a plurality of storage blocks, the plurality of storage blocks comprising at least a first storage block having index values that each reference a range of index values in a second storage block.

13. The computer system of claim 8, wherein the program instructions further cause the processor set to perform operations comprising:
providing a replace counter and a success counter, wherein the replace counter is incremented when a storage instruction error occurs and storage block page entry contents referenced by the plurality of input index values do not match currently-stored values in the host memory, and wherein the success counter is incremented when the storage instruction error occurs and the storage block page entry contents do match currently-stored values in the host memory; and
in response to the guest issuing a subsequent store index instruction, utilizing the currently-stored values in the host memory for execution of the subsequent store index instruction when a ratio of the success counter to the replace counter exceeds a threshold value.

14. The computer system of claim 13, wherein determining that the storage block page entry contents do or do not match the currently-stored values in the host memory comprises comparing a first hash of the storage block page entry contents to a second hash of the currently-stored values.

15. A computer program product comprising:
one or more computer-readable storage media; and
program instructions stored on the one or more computer-readable storage media to perform operations comprising:
obtaining memory index values for a host memory of a hypervisor and a guest memory of a guest of the hypervisor, wherein the guest memory is associated with a virtual device of the guest, wherein the host memory is accessible by a hardware adapter of the hypervisor, and wherein the host memory is configured to be synchronized with the guest memory;
intercepting a store index instruction issued by the guest, wherein the store index instruction comprises a plurality of input index values;
determining that the store index instruction is valid by comparing each input index value to a corresponding host memory index value in the host memory and to a corresponding adapter memory index value in an adapter memory; and
in response to determining that the store index instruction is valid, synchronizing the host memory shared with the adapter with the guest memory based on the plurality of input index values.

16. The computer program product of claim 15, wherein determining that the store index instruction is valid further comprises:
in response to determining that the store index instruction causes a ring wrap to occur in the guest memory or the host memory, determining that the store index instruction does not overwrite host memory index values currently held by the hardware adapter.

17. The computer program product of claim 15, wherein the store index instruction comprises a store control program queue controls instruction that stores a state of one or more input/output queues.

18. The computer program product of claim 15, wherein the program instructions further perform operations comprising:
executing the store index instruction by the hardware adapter.

19. The computer program product of claim 15, wherein the guest memory and the host memory each comprise a plurality of storage blocks, the plurality of storage blocks comprising at least a first storage block having index values that each reference a range of index values in a second storage block.

20. The computer program product of claim 15, wherein the program instructions further perform operations comprising:
providing a replace counter and a success counter, wherein the replace counter is incremented when a storage instruction error occurs and storage block page entry contents referenced by the plurality of input index values do not match currently-stored values in the host memory, and wherein the success counter is incremented when the storage instruction error occurs and the storage block page entry contents do match currently-stored values in the host memory; and
in response to the guest issuing a subsequent store index instruction, utilizing the currently-stored values in the host memory for execution of the subsequent store index instruction when a ratio of the success counter to the replace counter exceeds a threshold value.
